(19) United States
(12) Patent Application Publication
(10) Pub. No.: US 2019/0378371 A1
(43) Pub. Date: Dec. 12, 2019

(54) GAME DEVICE AND GAME METHOD

(71) Applicant: SEGA SAMMY CREATION INC., Yokohama-shi, Kanagawa (JP)

(72) Inventor: Taiji Sugai, Yokohama-shi (JP)

(21) Appl. No.: 16/341,580

(22) PCT Filed: Oct. 13, 2016
(86) PCT No.: PCT/JP2016/080441

§ 371 Date: Apr. 12, 2019

(51) Int. Cl. G07F 17/32

(52) U.S. Cl. CPC G07F 17/3211; G07F 17/3288; G07F 17/323; G07F 17/3244

(57) ABSTRACT

A game device comprises a control unit, a storage unit, and a display unit. The control unit is configured to execute a program stored in the storage unit to implement a function of displaying a roulette and a bet area on the display unit, a function of acquiring information on a bet position in the bet area in accordance with an instruction of a player, and a function of highlighting a position on the roulette corresponding to the bet position.

### CROSS-REFERENCE TO RELATED APPLICATIONS

This application is the U.S. national phase of the International Patent Application No. PCT/JP2016/080441 filed Oct. 13, 2016, the entire content of which is incorporated herein by reference.

### TECHNICAL FIELD

The present disclosure relates to a game device and a game method.

### BACKGROUND

In recent years, various game devices have been developed. For example, Japanese Translation of PCT Application No. 2010-502403 discloses a device capable of playing a roulette game. In the roulette game, a player selects a position (number) to bet, for example, by placing a chip on a bet area.

### SUMMARY

Generally, the arrangement of the numbers displayed on a roulette is not in numerical order (for example, in descending or ascending order). Thus, the player sometimes takes time to specify the position of a betted number out of numbers displayed on the roulette.

The present disclosure has been made in view of the foregoing circumstances, and an object of the disclosure is to provide a technique for making it easier to know the position on the roulette corresponding to a bet position.

A game device according to one embodiment is a game device comprising a control unit, a storage unit, and a display unit, wherein the control unit is configured to execute a program stored in the storage unit to implement a function of displaying a roulette and a bet area on the display unit, a function of acquiring information of a bet position in the bet area in accordance with an instruction of a player, and a function of highlighting a position on the roulette corresponding to the bet position.

A game device according to one embodiment comprises a control unit, a storage unit from which data is read and to which data is written by the control unit, and a display unit, wherein the control unit is programmed to cause the display unit to display images of a roulette and a bet area on the basis of the data read from the storage unit, specify a bet position in the bet area on the basis of the data read from the storage unit in accordance with a command, and highlight an image at a position on the roulette corresponding to the specified bet position on the basis of the data read from the storage unit.

A game method according to an embodiment is a game method performed by a device comprising a control unit, a storage unit, and a display unit, wherein the control unit executes a program stored in the storage unit to perform displaying a roulette and a bet area on the display unit, acquiring information of a bet position in the bet area in accordance with an instruction of a player, and highlighting a position on the roulette corresponding to the bet position.

According to an embodiment, it is possible to provide a technique for making it easier to know the position on the roulette corresponding to the bet position.

### BRIEF DESCRIPTION OF DRAWINGS

Various embodiments are illustrated in the drawings, in which:

FIG. 1 is an external perspective view of a game device according to one embodiment.

FIG. 2 is a block diagram illustrating a main hardware configuration of the game device according to the embodiment.

FIG. 3 is a block diagram illustrating a main functional configuration of the game device according to the embodiment.

FIG. 4 is a flowchart for describing processing by the game device according to the embodiment.

FIG. 5 is a diagram illustrating an example of a video displayed on a display unit according to the embodiment.

FIG. 6 is a diagram illustrating an example of a picture displayed on the display unit according to the embodiment.

### DETAILED DESCRIPTION

An embodiment of the present disclosure will be described below with reference to the drawings. However, the embodiment described below is merely an example, and there is no intention to exclude the application of various modifications and techniques not explicitly described below. That is, embodiments can be implemented with various modifications (combining the respective examples, etc.).

Further, in the following description of the drawings, the same or similar parts are denoted by the same or similar reference numerals. The drawings are schematic and do not necessarily correspond to actual dimensions, ratios, and the like. Between mutual drawings, differences in relation of their dimensions and ratios may also be included.

A game device and a game method according to an embodiment will be described below with reference to the drawings.

### Hardware Configuration Example of Game Device

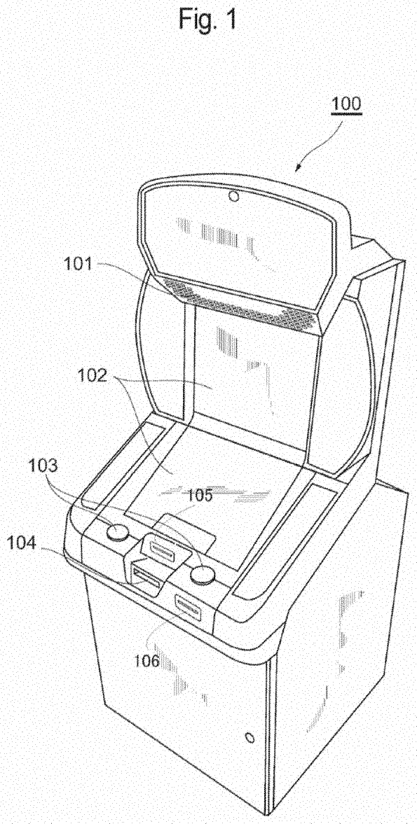

FIG. 1 is an external perspective view of the game device according to the embodiment. The game device 100 illustrated in FIG. 1 is a game device installed in a casino, an amusement facility, or the like. In the present embodiment, a player can play a roulette game by using the game device 100.

As illustrated in FIG. 1, the game device 100 comprises a speaker 101, a display device 102, an operation input device 103, a card reading device 104, a bill insertion device 105, and a ticket payout device 106 in appearance. The speaker 101 is sound output means for outputting voice guidance and effect sound of a game. The display device 102 is display means for displaying images (for example, still images, moving images, pictures, etc.) for expressing or presenting the game. The operation input device 103 is configured to include a plurality of operation buttons, and receives input of an instruction from the player to the game device via the operation buttons. It is noted that the operation input device 103 is not limited to such a configuration, and any configuration may be adopted as long as the configuration allows the player to input instructions, such as a touch panel or an operation stick. The card reading device 104 is a card reader that reads information from a card owned by the player. The bill insertion device 105 is a device that reads inserted bills and tickets. The ticket payout device 106 is ticket output means for paying out a card to the player.

The card to be read by the card reading device 104 is a medium in which gaming information of the player is stored. In the card, for example, points and the like acquired depending on gaming conditions of the player can be additionally stored. The player can obtain various services depending on the information stored in the card, but the contents stored in the card do not affect the gamming result.

Further, the game device 100 comprises a computing device therein as a control device that totally controls the game device 100.

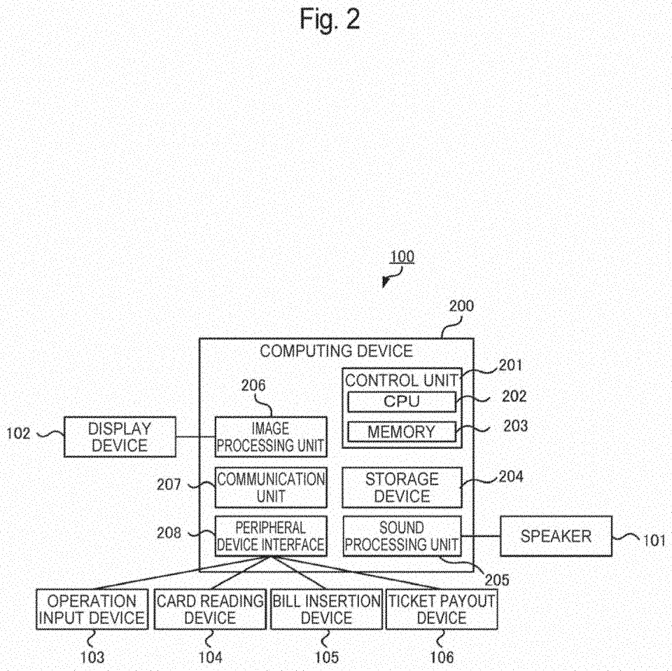

With reference to FIG. 2, an example of the hardware configuration of a computing device 200 included inside the game device 100 will be described. As illustrated in FIG. 2, the computing device 200 comprises, as a main hardware configuration, a control unit 201, a storage device 204, a sound processing unit 205, an image processing unit 206, a communication unit 207, and a peripheral device interface 208.

The control unit 201 comprises a CPU (Central Processing Unit) 202 and a memory 203. The computing device 200 controls processing and operations of another hardware configuration to implement various functions by, for example, executing a predetermined software program (for example, a game software program) stored in the memory 203 and the storage device 204 by the CPU 202. That is, under the control of the control unit 201, the computing device 200 implements a game function in cooperation with another hardware by executing a predetermined program. It is noted that FIG. 2 illustrates only the main configuration of the computing device 200, and the computing device 200 also comprises other configurations of general information processing devices.

The storage device 204 is composed of a hard disk or the like. In the storage device 204, data reading and writing are performed by the control unit 201. That is, in the storage device 204, data such as a software program necessary for the processing in the computing device 200 is written and data as a result of the processing is written. The sound processing unit 205 performs various kinds of sound processing under the control of the control unit 201. The image processing unit 206 performs various kinds of graphics processing under the control of the control unit 201. The communication unit 207 is an interface enabling communication with a server or another game device. The peripheral device interface 208 is an interface enabling the computing device 200 to communicate with peripheral devices such as the operation input device 103, the card reading device 104, the bill insertion device 105, and the ticket payout device 106.

### Functional Configuration Example of Game Device

Next, an example of the functional configuration of the game device 100 of the present embodiment will be described.

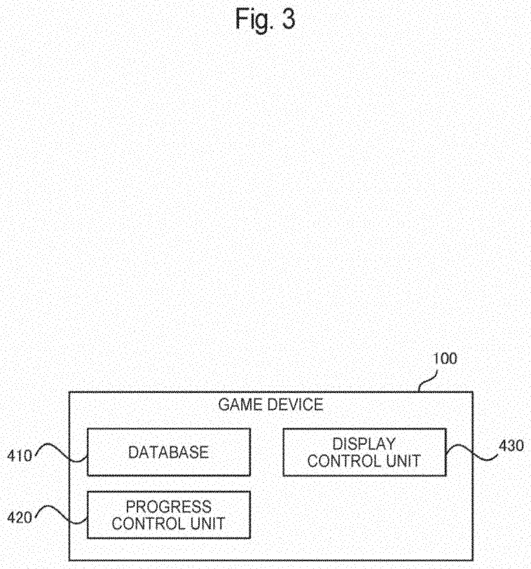

FIG. 3 is a block diagram illustrating a functional configuration of the game device 100 of the present embodiment. As illustrated in FIG. 3, the game device 100 mainly comprises, as a functional configuration, a database 410, a progress control unit 420, and a display control unit 430. Their functional configuration can be implemented through cooperation between the program (software) and the hardware of the game device 100.by, for example, loading a game software program stored in a storage unit such as the storage device 204 or the like in the memory 203 and executing the game software program by the control unit 201. It is noted that, in addition to the functions illustrated in FIG. 3, the game device 100 has other functions of general game devices, but the explanation thereof will be omitted here for the sake of convenience.

The database 410 stores various information such as information necessary for processing executed in the game device 100 and information generated by the processing. The database 410 is, for example, a control software program for controlling progress of the game, image (for example, still image, moving image etc.) data and sound data for expressing or presenting the game, data on the state of the game in progress (comprising parameters), and the like.

The progress control unit 420 executes processing of controlling the progress of the game in accordance with operations on the game device 100 by the player of the game and the control software program stored in the database 410. In particular, the progress control unit 420 controls progress of a game such as a roulette game.

The display control unit 430 controls display of images such as still images and moving images for expressing or presenting a game on the display device 102. Control of the display is performed in accordance with instructions from the progress control unit 420 and the player, or the like.

### Processing Flow

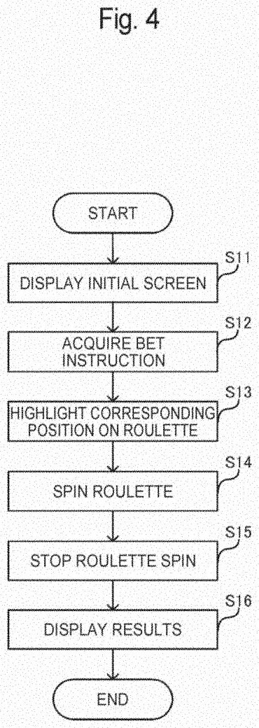

Next, with reference to FIG. 4, an example of a processing flow executed during progress of the game in the game device 100 will be described. Here, processing executed during progress of a roulette game will be described as an example. This processing is started when the game device 100 receives an instruction to start the roulette game from the player.

First, in step S11, the progress control unit 420 outputs a command to display an initial screen of the roulette game to the display control unit 430. In accordance with the command, the display control unit 430 performs control for displaying images of a roulette and a bet area on the display device 102 on the basis of data read from the database 410. Thereafter, the processing proceeds to step S12.

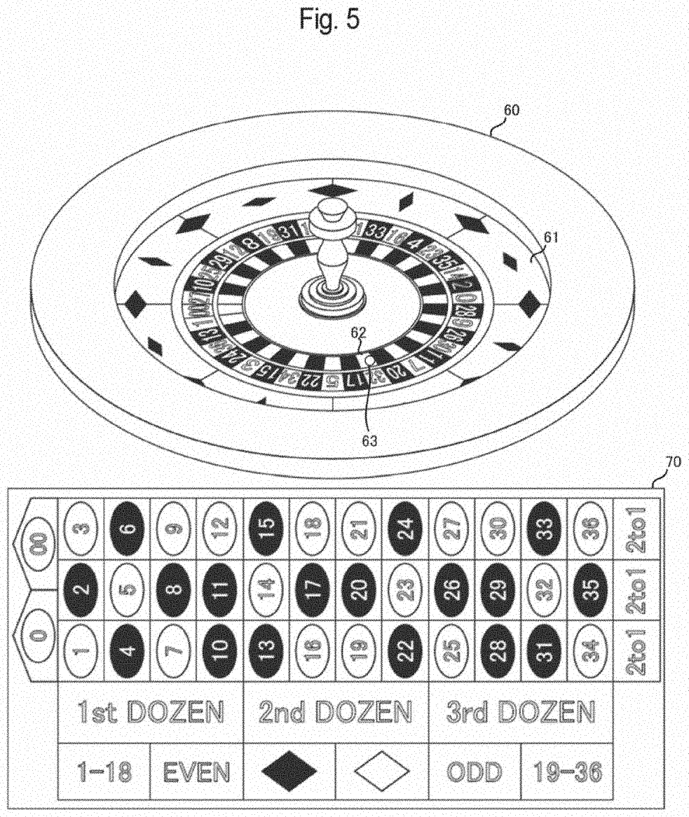

With reference to FIG. 5, an example of an image displayed on the display device 102 in the processing of step S11 of FIG. 4 will be described. FIG. 5 illustrates images of a roulette 60 and a bet area 70.

In the roulette 60, a wheel 61, a pocket 62, and a ball 63 are illustrated. The pocket 62 is one of a plurality of pockets provided on the wheel 61. The ball 63 moves on the wheel 61 by being thrown, then falls into one of the pockets and stops moving. In the example of FIG. 5, the ball 63 is contained within the pocket 62. In the example of FIG. 5, 38 pockets are provided on the wheel 61. The number of pockets provided on the wheel 61 is not limited to this and can be any number.

Further, each pocket on the wheel 61 is associated with a mark indicating any one of 0 to 36 and 00 and the marks are displayed on the wheel 61. For example, a mark indicating the number “32” is displayed in association with the pocket 62 (that is, a mark indicating “32” is displayed at a position adjacent to the pocket 62). Further, the arrangement of the marks indicating the numbers from 0 to 36 is not the order of the numerical serial numbers. The display of these marks is arranged in a predetermined order.

The bet area 70 is an area for indicating the bet content of the player as to which pocket on the wheel 61 the thrown ball 63 falls as described later. The bet area 70 is sectioned so as to be able to indicate the expected position (bet position) of the player. In the bet area 70, a plurality of sections are displayed. In each section, any one of “0” to “36”, “00”, “1st DOZEN”, “2nd DOZEN”, “3rd DOZEN”, “1-18”, “19-31”, “EVEN”, “ODD”, and a diamond mark is displayed. The player can select a position (number) for betting by selecting any section or any boundary of sections through the operation input device 103.

The explanation of FIG. 4 is returned back. In step S12, the progress control unit 420 acquires information on the bet content of the player on the basis of the data read from the database 410 in association with an operation instruction through the operation input device 103 by the player. The information on the bet content comprises, for example, information on a bet position and an amount of a bet by the player. That is, acquiring the information on the bet content comprises specifying the bet position.

In step S13, the progress control unit 420 outputs a display command corresponding to the information on the bet content acquired in step S12 to the display control unit 430. In accordance with the display command, the display control unit 430 performs control for displaying an image indicating the bet content of the player on the display device 102 on the basis of data read from the database 410. For example, the display control unit 430 can display an image of chips at the bet position on the image of the bet area displayed on the display device 102, according to the bet position indicated by the information on the bet content of the player.

In addition, the display control unit 430 can highlight the position corresponding to the bet position on the image of the roulette displayed on the display device 102.

The display control unit 430 can also change the type of the image of chips displayed at the bet position, and the method of emphasizing the position corresponding to the bet position on the image of the roulette, according to the amount of the bet amount indicated by the information on the bet content.

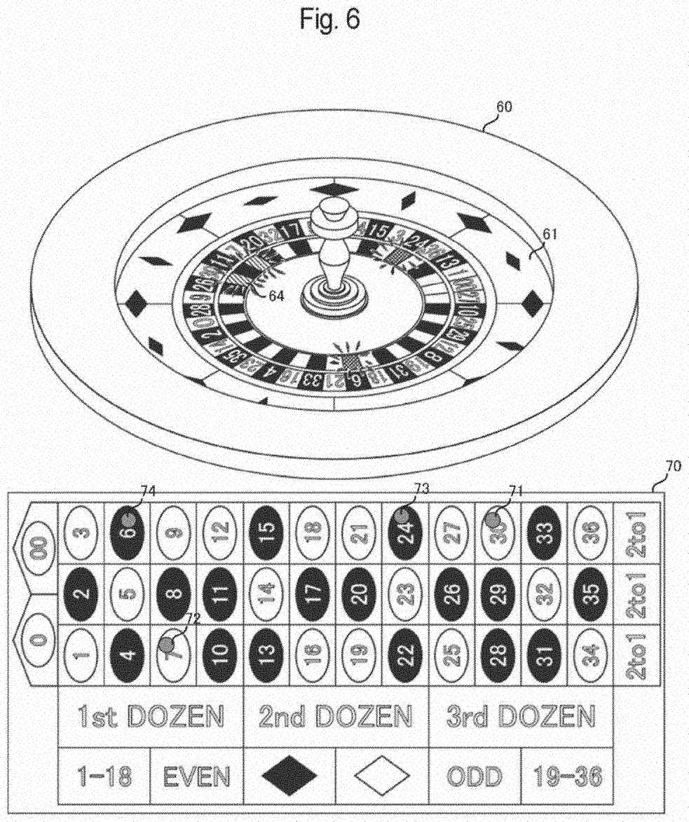

With reference to FIG. 6, an example of an image displayed on the display device 102 in the processing of step S13 of FIG. 4 will be described. In FIG. 6, similarly to FIG. 5, images of the roulette 60 and the bet area 70 are illustrated. Further, on the bet area 70, chip images 71 to 74 are illustrated at positions corresponding to bet positions indicated by information on the bet content of the player. In addition, on the roulette 60, the position corresponding to the bet position (the pocket on the roulette corresponding to the bet position) is highlighted. For example, the number at the bet position where the chip image 71 is placed is “30”, and the pocket corresponding to the number “30” indicated on the roulette 60 is highlighted.

As described above, according to the present embodiment, the display control unit 430 highlights the position on the roulette corresponding to the bet position on the bet area selected by the player. As a result, the player can more easily know the position on the roulette corresponding to the bet position.

The highlight of the position on the image of the roulette displayed on the display device 102 in step S13 of FIG. 4 can be changed according to the bet content. For example, the display control unit 430 can perform different highlight depending on a payout rate previously associated with the bet position selected by the player. As another example, the display control unit 430 can perform different highlight depending on an amount of a bet for the bet position selected by the player.

As a specific example of different highlight, the display control unit 430 can highlight the corresponding position on the image of the roulette with a more conspicuous display color as the payout rate of the selected bet position is higher or as the amount of the bet for the bet position is higher. Further, a more conspicuous flashing display as the payout rate of the selected bet position is higher or as the amount of the bet for the bet position is higher makes it possible to highlight the corresponding position on the image of the roulette.

Next, in step S14, after betting by the player is completed, the progress control unit 420 outputs, to the control unit 430, a display command for displaying moving images in which the wheel of the roulette is spun and a thrown ball circulates along the outside of the top surface of the wheel. In accordance with the command, the display control unit 430 performs control for displaying on the display device 102 the moving images in which the wheel of the roulette is spun and the ball circulates along the outside of the top surface of the wheel on the basis of data read from the database 410. At this time, in a state in which the highlight on the roulette in step S13 is performed, moving images in which the wheel is spun is displayed.

Thereafter, in step S15, the display control unit 430 performs control for displaying on the display device 102 moving images in which the ball falls in any one of the pockets of the wheel and the spin of the wheel is stopped on the basis of data read from the database 410.

In step S16, the progress control unit 420 determines the result of the game depending on whether or not the number associated with the pocket where the ball fell in step S15 corresponds to the betted position (number). The display control unit 430 performs control for displaying the determined game result on the display device 102.

As described above, according to the present embodiment, the display control unit 430 highlights the position on the roulette corresponding to the bet position on the bet area selected by the player. As a result, the player can more easily know the position on the roulette corresponding to the bet position during the period from when the wheel is spun to when the game result is determined.

The present disclosure is not limited to the above embodiment, and various other modifications can be made.

That is, the above-described embodiment is merely illustrative in all respects and is not construed as limiting, and various modifications can be adopted.

The highlight according to the embodiment described above can also be displayed during the betting time of the player so that it is possible to display to the player which position on the roulette the player is about to bet.

Further, since placing chips on the boundary line of four numbers will result in betting on the four numbers, in such a case, the corresponding four places for one chip can be highlighted. Further, when such betting is performed, the payout is low as compared with the case of betting on a single number. At this time, in order to make it easy for the player to know whether it is a high payout or a low payout, the highlight can be made in red for betting on a single number and in yellow for betting on four places.

Further, it is not necessary to highlight for all betting. Since “RED, BLACK”, “EVEN, ODD”, and the like are easy to see for the player, highlight therefor can be omitted. Whether or not such highlight is performed may be set by the player.

A program for implementing each embodiment described above may be stored in a recording medium. Using this recording medium makes it possible to install the above program in a computer. Here, the recording medium storing the program may be a non-transitory recording medium. The non-transitory recording medium is not particularly limited, but it may be a recording medium such as a CD-ROM, for example.

### LIST OF REFERENCE NUMERALS

100 Game device
101 Speaker
102 Display device
103 Operation input device
104 Card reading device
105 Bill insertion device
106 Ticket payout device
201 Control unit
202 CPU
203 Memory
204 Storage device
205 Sound processing unit
206 Image processing unit
207 Communication unit
208 Peripheral device interface

1. A game device, comprising a control unit, a storage unit, and a display unit, wherein the control unit is configured to execute a program stored in the storage unit to implement:
a function of displaying a roulette and a bet area on the display unit;
a function of specifying a bet position in the bet area in accordance with an instruction of a player; and
a function of highlighting a position on the roulette corresponding to the bet position.

2. The game device according to claim 1, wherein highlighting the position on the roulette includes performing different highlight depending on a payout rate previously associated with the specified bet position.

3. The game device according to claim 1, wherein highlighting the position on the roulette includes performing different highlight depending on an amount of a bet for the specified bet position.

4. The game device according to claim 1, wherein highlighting the position on the roulette includes highlighting a pocket on the roulette corresponding to the specified bet position.

5. The game device according to claim 1, wherein highlighting the position on the roulette includes at least using different display color or performing flashing display.

6. A game device, comprising:
a control unit;
a storage unit from which data is read and to which data is written by the control unit; and
a display unit,
wherein the control unit is programmed to:
cause the display unit to display images of a roulette and a bet area on the basis of the data read from the storage unit;
specify a bet position in the bet area on the basis of the data read from the storage unit in accordance with a command; and
highlight an image at a position on the roulette corresponding to the specified bet position on the basis of the data read from the storage unit.

7. A game method performed by a device including a control unit, a storage unit, and a display unit, wherein the control unit executes a program stored in the storage unit to perform:
displaying a roulette and a bet area on the display unit;
acquiring information of a bet position in the bet area in accordance with an instruction of a player; and
highlighting a position on the roulette corresponding to the bet position.
